(19) United States
(12) Patent Application Publication
(10) Pub. No.: US 2020/0279549 A1
(43) Pub. Date: Sep. 3, 2020

(54) VOICE CLONING FOR HEARING DEVICE

(71) Applicant: Starkey Laboratories, Inc., Eden Prairie, MN (US)

(72) Inventor: Thomas Burns, St. Louis Park, MN (US)

(21) Appl. No.: 16/802,783

(22) Filed: Feb. 27, 2020

Related U.S. Application Data
(60) Provisional application No. 62/811,923, filed on Feb. 28, 2019.

(51) Int. Cl. G10L 13/04; G10L 13/047; H04R 25/00; G10L 13/033

(52) U.S. Cl. CPC G10L 13/043; G10L 13/047; H04R 2225/43; G10L 13/033; H04R 25/505

(57) ABSTRACT

Various embodiments of a hearing device and methods of operating such hearing device are disclosed. The hearing device includes a receiver and a controller. The receiver includes at least one driver to generate sound. The controller includes one or more processors operably coupled to the receiver to control sound generated by the hearing device. The controller is configured to generate sound using the receiver based on at least cloned voice data.

This application claims the benefit of U.S. Provisional Application No. 62/811,923, filed Feb. 28, 2019, the disclosure of which is incorporated by reference herein in its entirety.

### BACKGROUND

Hearing devices, such as hearing aids, can be used to transmit sounds to one or both ear canals of a user. Some hearing devices can include electronic components disposed within a housing that is placed in a cleft region that resides between an ear and a skull of the user. Such housings typically can be connected to an earpiece that is disposed in an ear canal of the ear of the user. Some hearing devices can include electronic components disposed within a custom molded housing that resides in the ear canal of the user.

Further, some hearing devices can provide an audible signal that communicates information to the user. Such signals can take the form of tones or a prerecorded voice message.

### SUMMARY

In general, the present disclosure provides various embodiments of a hearing device and a method of operating such device. In one or more embodiments, the hearing device can be adapted to generate sound based on a cloned voice or cloned voice parameters. Such sound can include one or more auditory messages that can be provided to a user of the hearing device.

In one aspect, the present disclosure provides a hearing device including a receiver and a controller. The receiver includes at least one driver to generate sound. The controller includes one or more processors operably coupled to the receiver to control sound generated by the hearing device. The controller is configured to generate sound using the receiver based on at least cloned voice data.

In another aspect, the present disclosure provides a method that includes generating sound based on at least cloned voice data using a receiver of a hearing device.

### BRIEF DESCRIPTION OF THE DRAWINGS

Throughout the specification, reference is made to the appended drawings, where like reference numerals designate like elements, and wherein:

FIG. 1 is a schematic perspective view of a hearing device.

FIG. 2 is a schematic perspective view of a housing of the hearing device of FIG. 1 with circuitry exposed.

FIG. 3 is a schematic block diagram of the hearing device of FIGS. 1 and 2 configured to generate sound based on cloned voice data.

FIG. 4 is a schematic block diagram of a peripheral computing device for generating cloned voice data.

FIG. 5 is a schematic flow diagram of an illustrative method, or process, for generating sound based on cloned voice data.

FIG. 6 is a schematic flow diagram of an illustrative method, or process, for generating cloned voice data.

### DETAILED DESCRIPTION

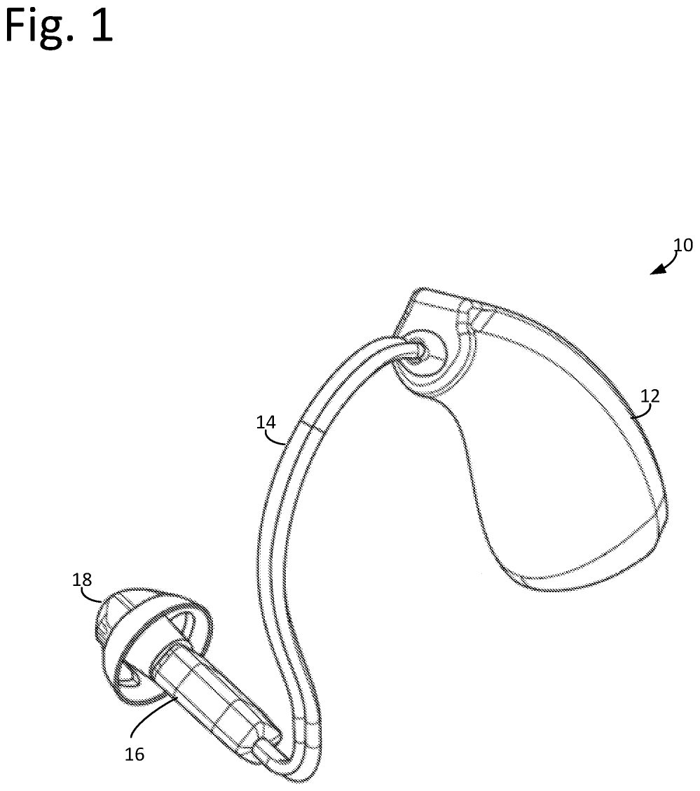

Exemplary methods, apparatus, and systems shall be described with reference to FIGS. 1-6. It will be apparent to one skilled in the art that elements or processes from one embodiment may be used in combination with elements or processes of the other embodiments, and that the possible embodiments of such methods, apparatus, and systems using combinations of features set forth herein is not limited to the specific embodiments shown in the Figures and/or described herein. Further, it will be recognized that the embodiments described herein may include many elements that are not necessarily shown to scale. Still further, it will be recognized that timing of the processes and the size and shape of various elements herein may be modified but still fall within the scope of the present disclosure, although certain timings, one or more shapes and/or sizes, or types of elements, may be advantageous over others.

In general, the present disclosure provides various embodiments of a hearing device and a method of operating such device. In one or more embodiments, the hearing device can be adapted to generate sound based on a cloned voice or cloned voice parameters. Such sound can include one or more auditory messages that can be provided to a user of the hearing device.

Prerecorded messages can be utilized with hearing devices to provide information to the user. Such prerecorded messages can, however, consume memory and processing resources that are available to the hearing device. One or more embodiments of hearing devices describe herein can provide auditory messages to the user that can reduce the utilization of such resources.

It may be described that the present disclosure includes sound generated from cloned voice data. The disclosure herein will use the terms “voice data,” “cloned voice parameter,” and “cloned voice data.” It is to be understood as used herein that voice data can include data generated by a microphone from sound of a voice received by the microphone. Voice data may be stored in memory and transferred between electronic devices.

It is to be understood as used herein that cloned voice parameter may include the linguistic and acoustical characteristics of a specific person's voice and not a ubiquitous person. These linguistic and acoustical characteristics may be parameterized in multiple dimensions based on voice data using any of neural networks, machine learning, deep learning, artificial intelligence (AI), etc. A cloned voice parameter may be generated based on voice data. The cloned voice parameter may include, e.g., Mel-Cepstral Coefficients (MCCs), Band Aperiodicities (BAPs), log scale fundamental frequencies (log Fo), etc. When parameterizing linguistic characteristics of voice data, MCCs can be computed by segmenting the voice data into consecutive frames, estimating the power spectrum for each frame, and applying Mel filters to the power spectra. Mel filters may be based on the Mel scale of pitches as perceived by listeners to be equally distant from one another, summing the energy in each filter, computing the logarithm of all energy, taking the discrete cosine transform (DCT) of the log energies, and keeping the desired DCT coefficients while discarding those DCT coefficients related to instantaneous changes in the filterbank energies. The BAP may represent the spectral power ratio between the voice data signal and the aperiodic component of the signal. The log Fo is the lowest frequency of a periodic waveform within the voice data, regardless of its relative level to harmonics.

During a learning phase, the cloned voice parameter may be updated over time frame intervals. Time frame intervals can be approximately 10 milliseconds to 40 milliseconds. Time frame intervals may include a 5-millisecond shift overlap. Furthermore, the cloned voice parameters may be multidimensional. For example, 60-dimensional MCCs, 25 BAPs, and the log Fo can be extracted from every 20-millisecond voice data frame while being updated every 5 milliseconds. Advantageously, updating the cloned voice parameter during the learning phase may allow the cloned voice parameter to be developed and refined to provide a more accurate cloned voice from the cloned voice parameter. The learning phase may be initiated by a user to develop a cloned voice parameter for a friend or relative in real time. Furthermore, the learning phase could include determining the cloned voice parameter from prerecorded sound data from a voice. Once the learning phase is completed, updates to the cloned voice parameter may be discontinued.

It is to be understood as used herein that cloned voice data may include data generated based on at least a cloned voice parameter. The cloned voice parameter may be used to generate the cloned voice data using various systems and methods, including a text-to-speech generator, a vocoder, modulating ubiquitous speech based on the cloned voice parameter, parametric speech production models, acoustical modeling of the vocal tract, etc. Advantageously, providing a hearing device or a device or controller peripheral to the hearing device that can generate cloned voice data based on a cloned voice parameter can provide auditory messages to the user that can reduce the utilization of memory and processing resources.

Hearing devices worn on, in, or behind the ear can be configured to provide an audible signal communicating various information to the user. Such signals may take the form of tones or a prerecorded voice message. If the latter, hardware resources within the hearing device may limit either the length of the prerecorded message or its sound quality. For example, more digital memory may be needed to store longer messages or messages of higher sound-quality. It may be beneficial to provide compact, unique, and more-pleasing auditory messages within hearing devices and to accomplish this without making hearing devices larger and more cumbersome due to electronic hardware or software resource needs.

As described herein, speech synthesizers may be used to clone a voice using either a hearing device and/or a peripheral computing device. When using the peripheral computing device, cloned voice data may be generated by the peripheral computing device and transmitted to the hearing device. The hearing device may then generate sound based on the cloned voice data received from the peripheral computing device. Source material for the cloned voice data may contain spoken or recorded speech (e.g., movie soundtracks, historical recordings, expressive audiobooks, etc.). Cloned voice parameters may be used, e.g., by a vocoder or text-to-speech (TTS) generator to synthesize a new voice message (e.g., cloned voice data) with life-like precision. In one or more embodiments, source material may be acquired from any public, out-of-copyright recording of a posthumous person's corpus of audio recordings. For example, a hearing device may generate sound of Humphrey Bogart saying “Here's listening in noise, kid.” In one or more embodiments, the source material may be obtained from a person (e.g., licensed from a famous person, recorded from a family member, acquired from the user). For example, a hearing device may announce calendar reminders such as “It's time to take your medication, Grampa” using cloned voice data of a grandchild's voice. This allows the hearing device to be more personalized for the user. In a further example, a hearing device may use cloned voice data of the user's voice to allow the user to talk to themselves, e.g., in a self-deprecating, humorous tone. In one or more embodiments, the source material may be licensed from a cartoon or movie network. For example, a pediatric hearing device may use cloned voice data of SpongeBob SquarePants™ to make announcements to the child user.

Voice-cloning methods and processes described herein may be performed independently from the hearing device prior to a user's original fitting. Cloned voice parameter values for MCCs, BAPs, and log Fo may be determined using various AI methods, as described herein. Cloned voice parameters may be used in a vocoder or a TTS generator to create stand-alone recordings of the cloned voice (e.g., cloned voice data). The recordings can then be uploaded to the hearing device and stored in memory.

In one embodiment, a plurality of cloned voices may be offered during an initial hearing device fitting for a user to choose from. Fitting software of a peripheral computing device can use cloned voice parameters to generate (e.g., synthesize) cloned voice data (e.g., cloned voice recordings). The cloned voice data is then transmitted from the peripheral computing device to the hearing device where the cloned voice data is stored. The hearing device can then generate sound (e.g., indicators, reminders, etc.) based on the cloned voice data. Furthermore, different cloned voices may be selected for different types of alerts or reminders. For example, a first cloned voice may be selected and preset for medication reminders and a second cloned voice may be selected and preset for alerts. Additionally, cloned voices may be selected based on the hearing capabilities of the user. For example, some types or qualities of cloned voices may be easier for a user to hear such as, for example, accents, gender, average frequency, etc.

In a further embodiment, cloned voice parameters are transmitted to the hearing device and used with a vocoder or TTS generator of the hearing device to generate (e.g., synthesize) the cloned voice data (e.g., messages, indicators, reminders, etc.).

In a still further embodiment, cloned voice parameters for a plurality of cloned voices may be stored in a peripheral computing device or cloud-based storage. The peripheral computing device or cloud-based storage generates cloned voice data and transmits the cloned voice data to the hearing device. The hearing device generates sound based on the cloned voice data received from the peripheral computing device or cloud-based storage. Cloned voice parameters may be updated (e.g., daily, weekly, monthly, etc.) to provide a variety of cloned voice data to the user.

An exemplary schematic perspective view of a hearing device 10 is shown in FIG. 1. The hearing device 10 may include a hearing device body 12, a receiver cable 14, a receiver 16, and an ear piece 18.

The receiver cable 14 may be coupled between the hearing device body 12 and the receiver 16. The ear piece 18 may be coupled to receiver 16. The receiver cable 14 may include an electrically conductive medium for providing electric signals from electronic components of the hearing device body 12 to the receiver 16. The receiver 16 can generate sound based on the electric signals provided by electronics of the hearing device 10. The ear piece 18 may allow receiver 16 to fit comfortably in a user's ear canal.

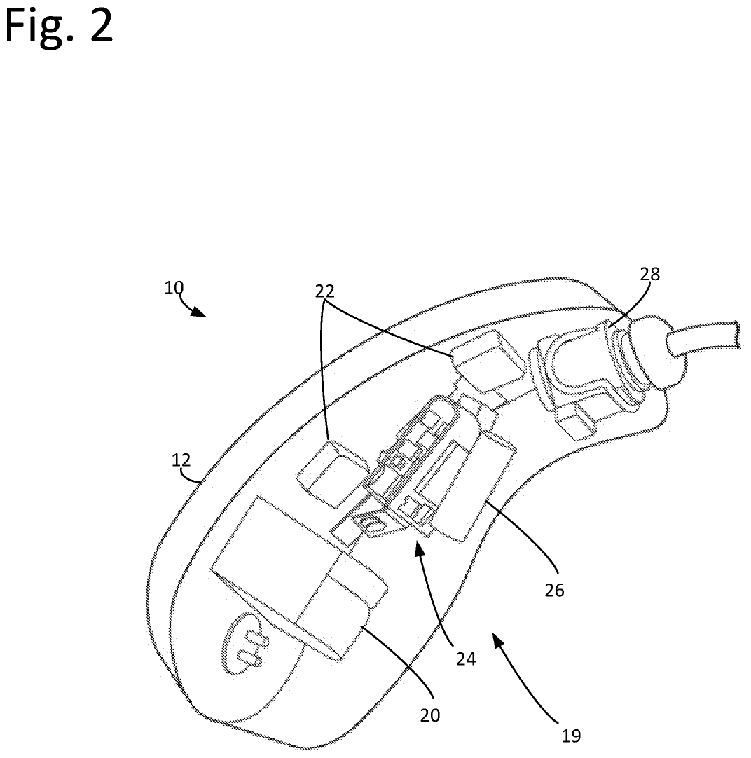

An exemplary schematic perspective view of the hearing device 10 with electronic components 19 within the hearing device body 12 exposed is shown in FIG. 2. The hearing device 10 can include any suitable electronic components 19. For example, the electronic components 19 inside the hearing device body 12 may include a battery 20, microphones 22, a circuit board 24, a telecoil 26, and a receiver cable plug 28.

The battery 20 may be electrically coupled to the circuit board 24 to provide power to the circuit board 24. Microphones 22 may be electrically coupled to the circuit board 24 to provide electrical signals representative of sound (e.g., audio data, etc.) to the circuit board 24. Telecoil 26 may be electrically coupled to the circuit board 24 to provide electrical signals representative of changing magnetic fields (e.g., audio data, etc.) to the circuit board 24. Circuit board 24 may be electrically coupled to the receiver cable plug 28 to provide electrical signals representative of sound (e.g., audio data, cloned voice data, voice data, etc.) to the receiver cable plug 28.

Microphones 22 may receive sound (e.g., vibrations, acoustic waves) and generate electronic signals (e.g., audio data, etc.) based on the received sound. Audio data may represent the sound that was received by microphones 22. Microphones 22 can be any type suitable for hearing devices such as electret, MicroElectrical-Mechanical System (MEMS), piezoelectric, or other type of microphone. Audio data produced by microphones 22 can be analog or digital. Microphones 22 may provide the audio data to circuit board 24.

Telecoil 26 may detect changing magnetic fields and generates electrical signals (e.g., audio data) based on the changing magnetic fields. For example, telecoil 26 can detect a changing magnetic field produced by a speaker in a telephone or a loop system and generate audio data based on the magnetic field produced by the speaker or loop system. Telecoil 26 may provide the electrical signals (e.g., audio data) to the circuit board 24. Using the telecoil 26, the hearing device 10 may filter out background speech and acoustic noise to provide a better and more focused listening experience for the user.

The receiver cable plug 28 may be configured to mechanically couple the receiver cable 14 to the hearing device body 12. The receiver cable plug 28 may be further configured to operably couple the receiver cable 14 to the circuit board 24. The receiver cable plug 28 may allow receiver cables and receivers to be replaced quickly and easily.

The circuit board 24 may include any suitable circuit components for operating hearing device 10. The circuit components of the circuit board 24 may include one or more of controllers and memory for executing programs of the hearing device 10. Circuit board 24 may additionally include any of an analog-to-digital converter (ADC), a digital-to-analog converter (DAC), a communication device, passive electronic components, amplifiers, or other components used for digital signal processing.

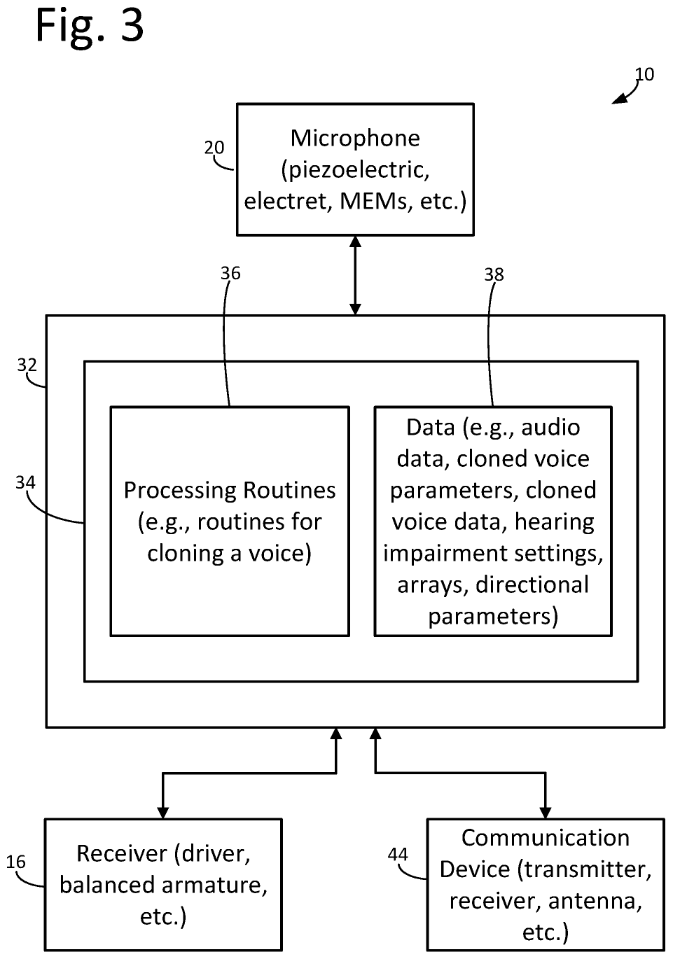

An exemplary system block diagram of the hearing device 10 for use in generating sound based on cloned voice data and/or generating cloned voice data as described herein is depicted in FIG. 3. The hearing device 10 may include a processing apparatus or a controller 32 and the microphone 20. Generally, the microphone 20 may be operably coupled to the controller 32 and may include any one or more devices configured to generate audio data from sound and provide the audio data to the controller 32. The microphone 20 may include any apparatus, structure, or device configured to convert sound into sound data. For example, the microphone 20 may include one or more diaphragms, crystals, spouts, application-specific integrated circuits (ASICs), membranes, sensors, charge pumps, etc. Sound data may include voice data when the sound received by the microphone 20 is the sound of a voice.

The sound data generated by the microphone 20 may be provided to the controller 32, e.g., such that the controller 32 may analyze, modify, store, and/or transmit the sound data. Further, such sound data may be provided to the controller 32 in a variety of different ways. For example, the sound data may be transferred to the controller 32 through a wired or wireless data connection between the controller 32 and the microphone 20.

The hearing device 10 may additionally include the receiver 16 operably coupled to the controller 32. Generally, the receiver 16 may include any one or more devices configured to generate sound. The receiver 16 may include any apparatus, structure, or devices configured to generate sound. For example, the receiver 16 may include one or more drivers, diaphragms, armatures, spouts, housings, suspensions, crossovers, etc. The sound generated by the receiver 16 may be controlled by the controller 32, e.g., such that the controller 32 may generate sound based on sound data. Sound data may include, for example, cloned voice data, voice data, hearing impairment settings, parametric speech production models, acoustical models of the vocal tract, etc.

The hearing device 10 may additionally include a communication device 44 operably coupled to the controller 32. Generally, the communication device 44 may include any one or more devices configured to transmit and/or receive data via a wired or wireless connection. The communication device 44 may include any apparatus, structure, or devices configured to transmit and/or receive data. For example, the communication device 44 may include one or more receivers, transmitters, transceivers, antennas, pin connector, inductive coils, near-field magnetic inductions (NFMI) coils, a tethered connection to an ancillary accessory, etc. The communication device 44 may transmit data (e.g., voice data, cloned voice parameters, cloned voice data, sensor data, hearing impairment data, log data, etc.) to a peripheral computing device. The communication device 44 may receive data (e.g., voice data, cloned voice parameters, cloned voice data, sensor data, hearing impairment settings, etc.) from the peripheral computing device.

Further, the controller 32 includes data storage 34. Data storage 34 allows for access to processing programs or routines 36 and one or more other types of data 38 that may be employed to carry out the exemplary methods, processes, and algorithms of generating cloned voice data or generating sound based on cloned voice data. For example, processing programs or routines 36 may include programs or routines for performing computational mathematics, matrix mathematics, Fourier transforms, compression algorithms, calibration algorithms, image construction algorithms, inversion algorithms, signal processing algorithms, normalizing algorithms, deconvolution algorithms, averaging algorithms, standardization algorithms, comparison algorithms, vector mathematics, analyzing voice data, generating cloned voice parameters, generating cloned voices, voice-cloning, detecting defects, statistical algorithms, or any other processing required to implement one or more embodiments as described herein.

Data 38 may include, for example, sound data (e.g., voice data, etc.), cloned voice parameters (e.g., MCCs, BAPs, and log Fo, etc.), cloned voice data (e.g., cloned voice messages, etc.), hearing impairment settings, arrays, meshes, grids, variables, counters, statistical estimations of accuracy of results, results from one or more processing programs or routines employed according to the disclosure herein (e.g., voice cloning, generating sound based on cloned voice data, etc.), or any other data that may be necessary for carrying out the one or more processes or methods described herein.

In one or more embodiments, the hearing device 10 may be controlled using one or more computer programs executed on programmable computers, such as computers that include, for example, processing capabilities (e.g., microcontrollers, programmable logic devices, etc.), data storage (e.g., volatile or non-volatile memory and/or storage elements), input devices, and output devices. Program code and/or logic described herein may be applied to input data to perform functionality described herein and generate desired output information. The output information may be applied as input to one or more other devices and/or processes as described herein or as would be applied in a known fashion.

The programs used to implement the processes described herein may be provided using any programmable language, e.g., a high level procedural and/or object orientated programming language that is suitable for communicating with a computer system. Any such programs may, for example, be stored on any suitable device, e.g., a storage media, readable by a general or special purpose program, computer, or a processor apparatus for configuring and operating the computer when the suitable device is read for performing the procedures described herein. In other words, at least in one embodiment, the hearing device 10 may be controlled using a computer readable storage medium configured with a computer program, where the storage medium so configured causes the computer to operate in a specific and predefined manner to perform functions described herein.

Alternatively, the controller 32 may be, for example, any fixed or mobile computer system (e.g., a personal computer or minicomputer). The exact configuration of the controller 32 is not limiting and essentially any device capable of providing suitable computing capabilities and control capabilities (e.g., control the sound output of the hearing device 10, the acquisition of data, such as audio data or sensor data) may be used. Further, various peripheral devices, such as a computer display, mouse, keyboard, memory, printer, scanner, etc. are contemplated to be used in combination with the controller 32. Further, in one or more embodiments, the data 38 (e.g., sound data, voice data, cloned voice parameters, cloned voice data, hearing impairment settings, an array, a mesh, a digital file, etc.) may be analyzed by a user, used by another machine that provides output based thereon, etc. As described herein, a digital file may be any medium (e.g., volatile or non-volatile memory, a CD-ROM, a punch card, magnetic recordable tape, etc.) containing digital bits (e.g., encoded in binary, trinary, etc.) that may be readable and/or writeable by controller 32 described herein. Also, as described herein, a file in user-readable format may be any representation of data (e.g., ASCII text, binary numbers, hexadecimal numbers, decimal numbers, audio, graphical) presentable on any medium (e.g., paper, a display, sound waves, etc.) readable and/or understandable by a user.

In view of the above, it will be readily apparent that the functionality as described in one or more embodiments according to the present disclosure may be implemented in any manner as would be known to one skilled in the art. As such, the computer language, the computer system, or any other software/hardware that is to be used to implement the processes described herein shall not be limiting on the scope of the systems, processes or programs (e.g., the functionality provided by such systems, processes or programs) described herein.

The methods described in this disclosure, including those attributed to the systems, or various constituent components, may be implemented, at least in part, in hardware, software, firmware, or any combination thereof. For example, various aspects of the techniques may be implemented by the controller 32, which may use one or more processors such as, e.g., one or more microprocessors, DSPs, ASICs, FPGAs, CPLDs, microcontrollers, or any other equivalent integrated or discrete logic circuitry, as well as any combinations of such components, image processing devices, or other devices. The term “processing apparatus,” “processor,” “processing circuitry,” or “controller” may generally refer to any of the foregoing logic circuitry, alone or in combination with other logic circuitry, or any other equivalent circuitry. Additionally, the use of the word “processor” may not be limited to the use of a single processor but is intended to connote that at least one processor may be used to perform the exemplary methods and processes described herein.

Such hardware, software, and/or firmware may be implemented within the same device or within separate devices to support the various operations and functions described in this disclosure. In addition, any of the described components may be implemented together or separately as discrete but interoperable logic devices. Depiction of different features, e.g., using block diagrams, etc., is intended to highlight different functional aspects and does not necessarily imply that such features must be realized by separate hardware or software components. Rather, functionality may be performed by separate hardware or software components or integrated within common or separate hardware or software components.

When implemented in software, the functionality ascribed to the systems, devices and methods described in this disclosure may be embodied as instructions on a computer-readable medium such as RAM, ROM, NVRAM, EEPROM, FLASH memory, magnetic data storage media, optical data storage media, or the like. The instructions may be executed by the controller 32 to support one or more aspects of the functionality described in this disclosure.

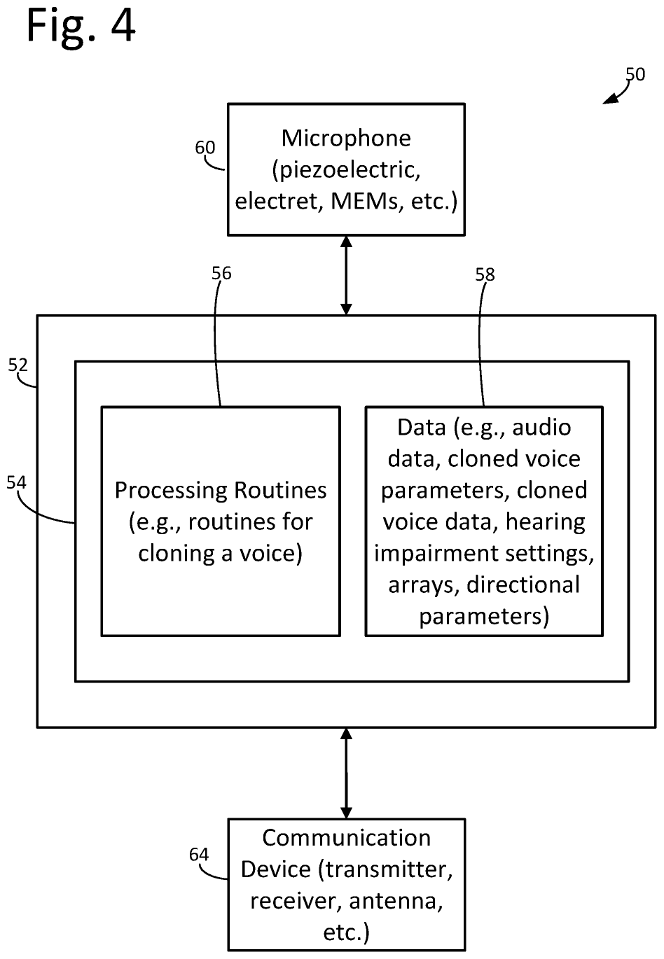

An exemplary system 50 for use in generating cloned voice data as described herein is depicted in FIG. 4. The system 50 may be the controller 32 of FIG. 3 in the alternative configuration described herein. The system 50 may be any suitable computing system or device, e.g., a cellular phone, a peripheral computing device, a tablet, etc. The system 50 may include a processing apparatus or processor 52 and a microphone 60. Generally, the microphone 60 may be operably coupled to the processing apparatus 52 and may include any one or more devices configured to generate audio data from sound and provide the audio data to the processing apparatus 52. The microphone 60 may include any apparatus, structure, or devices configured to convert sound into sound data. For example, the microphone 60 may include one or more diaphragms, crystals, spouts, application-specific integrated circuits (ASICs), membranes, sensors, charge pumps, etc. Sound data may include voice data when the sound received by the microphone 60 is sound of a voice.

The sound data generated by the microphone 60 may be provided to the processing apparatus 52, e.g., such that the processing apparatus 52 may analyze, modify, store, and/or transmit the sound data. Further, such sound data may be provided to the processing apparatus 52 in a variety of different ways. For example, the sound data may be transferred to the processing apparatus 52 through a wired or wireless data connection between the processing apparatus 52 and the microphone 60.

The system 50 may additionally include a communication device 64 operably coupled to the processing apparatus 52. Generally, the communication device 64 may include any one or more devices configured to transmit and/or receive data via a wired or wireless connection. The communication device may include any apparatus, structure, or devices configured to transmit and/or receive data. For example, the communication device 64 may include one or more receivers, transmitters, transceivers, antennas, pin connectors, inductive coils, NFMI coils, or a tethered connection to an ancillary accessory, etc. The communication device 64 may transmit data (e.g., voice data, cloned voice parameters, cloned voice data, sensor data, hearing impairment data, log data, etc.) to a hearing device, cloud-based storage, computing device, etc. The communication device 64 may receive data (e.g., voice data, cloned voice parameters, cloned voice data, sensor data, hearing impairment settings, parametric speech production models, acoustical models of the vocal tract, etc.) from a hearing device, cloud-based storage, computing device, etc.

Further, the processing apparatus 52 includes data storage 54. Data storage 54 allows for access to processing programs or routines 56 and one or more other types of data 58 that may be employed to carry out the exemplary methods, processes, and algorithms of generating cloned voice data or generating sound based on cloned voice data. For example, processing programs or routines 56 may include programs or routines for performing computational mathematics, matrix mathematics, Fourier transforms, compression algorithms, calibration algorithms, image construction algorithms, inversion algorithms, signal processing algorithms, normalizing algorithms, deconvolution algorithms, averaging algorithms, standardization algorithms, comparison algorithms, vector mathematics, analyzing voice data, generating cloned voice parameters, generating cloned voices, voice-cloning, detecting defects, statistical algorithms, or any other processing required to implement one or more embodiments as described herein.

Data 58 may include, for example, sound data (e.g., voice data, etc.), cloned voice parameters (e.g., MCCs, BAPs, and log Fo, etc.), cloned voice data (e.g., cloned voice messages, etc.), hearing impairment settings, arrays, meshes, grids, variables, counters, statistical estimations of accuracy of results, results from one or more processing programs or routines employed according to the disclosure herein (e.g., voice cloning, generating sound based on cloned voice data, etc.), or any other data that may be necessary for carrying out the one or more processes or methods described herein. In one or more embodiments, the system 50 may be controlled using one or more computer programs executed on programmable computers, such as previously described herein with respect to the system 20 of FIG. 3.

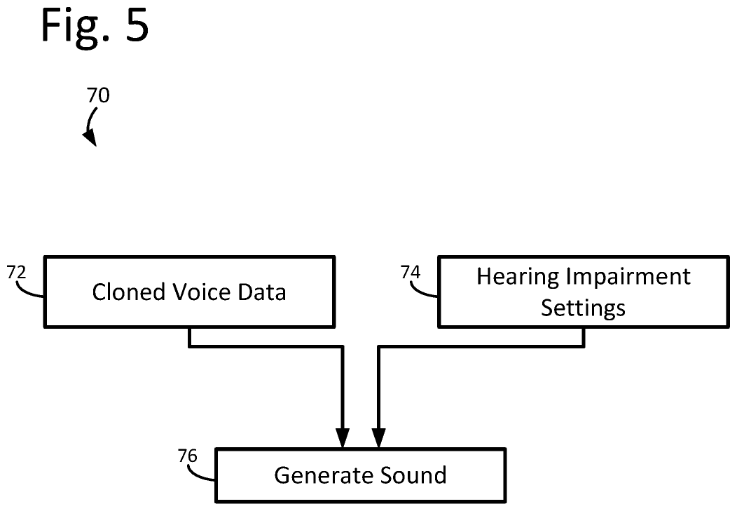

FIG. 5 is a flow diagram of an illustrative method or process 70 for generating sound using, or controlling the sound generated by, a hearing device (e.g., hearing device 10 of FIGS. 1-3). The method 70 may include providing cloned voice data at 72 and generating sound based upon the cloned voice data at 76, or providing cloned voice data at 72, providing hearing impairment settings at 74, and generating sound based on the cloned voice data and the hearing impairment settings at 76. The cloned voice data may be provided by the peripheral computing device 50 (e.g., cellular phone), cloud-based storage, the controller 32 of the hearing device 10, etc. In one or more embodiments, the cloned voice data may be generated using a vocoder or a TTS generator at 72. Further, for example, the cloned voice data may be generated based upon one or more cloned voice parameters at 72. In one or more embodiments, the sound may be generated further based on hearing impairment settings at 74. The hearing impairment settings may be provided by peripheral computing device 50 (e.g., cellular phone), cloud-based storage, the controller 32 of the hearing device 10, etc. The generated sound may be generated by the receiver 16 and controlled by the controller 32 of hearing device 10.

In one example, the sound of the cloned voice may be provided without applying hearing impairment settings. A user's perception of another person's voice may include the user's hearing loss. In such cases, generating sound based on the cloned voice data and the hearing impairment settings may alter the user's perception of the cloned voice. Instead, the user may set a volume of the cloned voice to any suitable level. However, in some examples, the user may be accustomed to hearing a person's voice reproduced with hearing impairment settings. In such examples, the sound may be generated using or based on the cloned voice data and hearing impairment settings. Advantageously, hearing devices may provide sound of the cloned voice in whatever way is more familiar to the user.

Additionally, users may adjust hearing impairment settings using a peripheral device based on the cloned voice. For example, a user may notice that user's perception of the cloned voice is altered. Such alteration may be caused by changes in the user's hearing impairment. The user may use a peripheral device to alter one or more impairment settings until the cloned voice sounds familiar to them. Such alterations may be stored or provided to an audiologist for review. Furthermore, such alterations may be monitored over time.

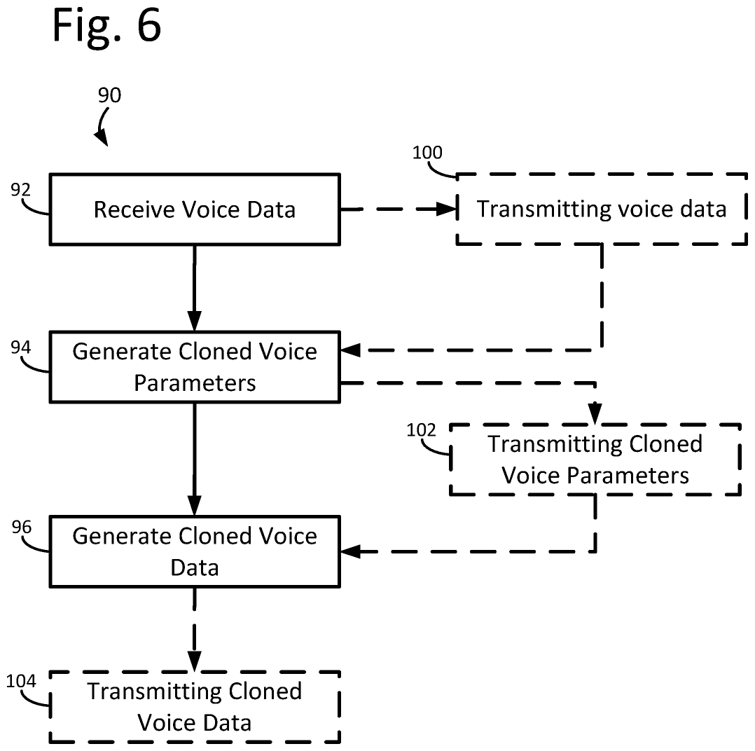

The cloned voice data provided at 72 can be generated using any suitable methods or processes. For example, the method or process 90 depicted in FIG. 6. The method 90 may include receiving voice data at 92. Voice data may be received from the microphone 20, the microphone 60, a peripheral computing device (e.g., system 50), cloud-based storage, etc. Voice data may be received and accumulated over time (e.g., hours, days, months, etc.).

Advantageously, voice data received from a microphone (e.g., microphone 20) of a hearing device (e.g., hearing device 10) may include head and torso acoustical scattering due to the placement of the microphone within the hearing device. Thus, the voice data provided by method 90 may include head and torso acoustical scattering correction. Such correction may be implemented in the form of a filter. The filter can be determined using empirical, analytical, or computational methods. An empirical filter can be determined under anechoic conditions where the filter represents the transfer function of a microphone placed in front of a subject's mouth to a microphone located in a hearing aid on or in the subject's ear while the subject is vocalizing. Additionally, or alternatively, the filter may be determined according to analytical methods using closed-form solutions to acoustical radiation from a point source on a sphere, where the sphere represents the user's head and a point source represents the user's mouth. Furthermore, the filter may be determined according to computational methods using boundary or finite element methods. Computational methods may differ from analytical methods in that the solutions of the computational methods are not closed form and are solved numerically. In both the computational and analytical methods, a transfer function may be determined as the ratio of sound pressures from a location in front of the user's mouth to a location representing the microphone on a hearing aid positioned on or in the ear. In the methods described herein, e.g., empirical, analytical, and computational, the resulting filter may be convolved with the real-time signal of the hearing aid microphone to simulate the pressure in front of the user's mouth. The convolved result may be used in a voice cloning process. Alternatively, the filter may be applied to stored data from the hearing aid microphone and used in a subsequent voice cloning process.

The method 90 may include generating cloned voice parameters based on the received voice data at 94. Cloned voice parameters may be generated, e.g., using neural networks, machine learning, deep learning, AI, etc. Cloned voice parameters may be generated over time as voice data is received and accumulated over time (e.g., hours, days, months, etc.). For example, a hearing device (e.g., hearing device 10 of FIGS. 1-3) may capture voice data of a user's family member over a time period, e.g., one week. During the time period cloned voice parameters may be generated as the voice data is captured by the hearing device 10. Cloned voice parameters may be generated using any suitable device or system such as the hearing device 10, computer, peripheral computing device, controller 32, processor, the system 50 of FIG. 4, etc.

The method 90 may include generating cloned voice data at 96 based on the generated cloned voice parameters. Cloned voice data may be generated using any suitable processes or methods, including use of a TTS generator or a vocoder. The generated cloned voice data may represent sound, including, for example, hearing device indicators, conversation, words, phrases, or other information of a cloned voice. Cloned voice data may be generated using any suitable device or system such as a hearing device (e.g., the hearing device 10 of FIGS. 1-3), computer, peripheral computing device, controller (e.g., controller 32), processor, the system 50 of FIG. 4, etc.

The method 90 may optionally include transmitting the voice data at 100. The voice data may be transmitted to a hearing device (e.g., the hearing device 10 of FIGS. 1-3), computer, peripheral computing device, controller (e.g., controller 32), processor, the system 50 of FIG. 4, etc. The voice data may be transmitted at 100 using any suitable device such as, for example, any of the communication devices 44 or 64 of FIGS. 3 and 4.

The method 90 may optionally include transmitting cloned voice parameters at 102. The cloned voice parameters may be transmitted to a hearing device (e.g., the hearing device 10 of FIGS. 1-3), computer, peripheral computing device, controller, processor, the system 50 of FIG. 4, etc. The cloned voice parameters may be transmitted using any suitable device such as, for example, any of the communication devices 44 or 64 of FIGS. 3 and 4.

Further, the method 90 may optionally include transmitting cloned voice data at 104. Cloned voice data may be transmitted to a hearing device (e.g., the hearing device 10 of FIGS. 1-3), computer, peripheral computing device, controller, processor, the system 50 of FIG. 4, etc. The cloned voice data may be transmitted using any suitable device such as, for example, any of the communication devices 44 or 64 of FIGS. 3 and 4.

Exemplary methods, apparatus, and systems herein allow for cloning voices. Cloned voices allow hearing devices to provide a customized experience. For example, a user can initiate a conversation with a celebrity or celebrities and the hearing device may respond in a voice or voices selected by a user. For example, the user may desire to have a conversation with members of The Beatles rock band. Cloned voice data generated based on the methods and processes described herein, may be transmitted from a peripheral computing device (e.g., cellular phone, tablet, computer, etc.) to the user's hearing device in response to user conversation. The cloned voice data may include words or phrases in the voice, e.g., of John Lennon, Paul McCartney, Ringo Starr, or George Harrison. Additionally, exemplary methods, apparatus, and systems may allow for hearing device indicators or conversations using voices of cartoon characters, user family members, or even the user's own voice.

All references and publications cited herein are expressly incorporated herein by reference in their entirety into this disclosure, except to the extent they may directly contradict this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

1. A hearing device comprising:
a receiver comprising at least one driver to generate sound; and
a controller comprising one or more processors and operably coupled to the receiver to control sound generated by the hearing device, the controller configured to generate sound using the receiver based on at least cloned voice data.

2. The hearing device of claim 1, wherein the controller is further configured to receive voice data, determine a cloned voice parameter based on the voice data, and generate the cloned voice data based on at least the cloned voice parameter.

3. The hearing device of claim 1, wherein the controller is further configured to receive a cloned voice parameter and generate the cloned voice data based on at least the clone voice parameter.

4. The hearing device of claim 1, further comprising a microphone to receive sound of a voice and generate voice data based on the received sound of the voice, and
wherein the controller is operably coupled to the microphone to receive the voice data and generate a cloned voice parameter based on the voice data.

5. The hearing device of claim 1, further comprising a communication device to transmit data to and receive data from a peripheral computing device, and
wherein the controller is operably coupled to the communication device to control data transmitted and received by the communication device.

6. The hearing device of claim 5, wherein the controller is further configured to receive a cloned voice parameter from the peripheral computing device using the communication device and to generate the cloned voice data based on at least the cloned voice parameter.

7. The hearing device of claim 5, wherein the controller is further configured to receive the cloned voice data from the peripheral computing device using the communication device.

8. The hearing device of claim 5, wherein the controller is further configured to send voice data to the peripheral computing device using the communication device and receive either a cloned voice parameter or the cloned voice data from the peripheral computing device using the communication device.

9. The hearing device of claim 1, wherein the controller is configured to generate the cloned voice data based on at least a cloned voice parameter using a text to speech generator.

10. The hearing device of claim 1, wherein the cloned voice parameter comprises at least a log scale fundamental frequency.

11. The hearing device of claim 1, wherein the controller is further configured to generate the sound using the receiver based on at least the cloned voice data and hearing impairment settings.

12. A method comprising generating sound based on at least cloned voice data using a receiver of a hearing device.

13. The method of claim 12, further comprising:
receiving voice data;
determining a cloned voice parameter based on the voice data; and
generating the cloned voice data based on at least the cloned voice parameter.

14. The method of claim 13, wherein receiving voice data comprises generating voice data from sound of a voice using a microphone.

15. The method of claim 12, further comprising:
receiving a cloned voice parameter from a peripheral computing device using a communication device; and
generating the cloned voice data based on at least the cloned voice parameter.

16. The method of claim 12, further comprising receiving the cloned voice data from a peripheral computing device using a communication device.

17. The method of claim 12, further comprising:
transmitting voice data to a peripheral computing device using a communication device; and
receiving the cloned voice data from the peripheral computing device using the communication device.

18. The method of claim 12, wherein generating the cloned voice is further based on at least a cloned voice parameter and a text to speech generator.

19. The method of claim 12, wherein the cloned voice parameter comprises at least a log scale fundamental frequency.

20. The method of claim 12, wherein generating the sound using the receiver is further based on at least the cloned voice data and hearing impairment settings.
